(19) United States
(12) Patent Application Publication
(10) Pub. No.: US 2024/0052821 A1
(43) Pub. Date: Feb. 15, 2024

(54) AIR COMPRESSOR SYSTEM

(71) Applicant: Continental Automotive Technologies GmbH, Hannover (DE)

(72) Inventor: Silviu Dorel Ioia, Feisa (RO)

(73) Assignee: Continental Automotive Technologies GmbH, Hannover (DE)

(21) Appl. No.: 18/448,230

(22) Filed: Aug. 11, 2023

(30) Foreign Application Priority Data
Aug. 11, 2022 (EP) 22465549.8
Aug. 12, 2022 (DE) 10 2022 208 399.

(51) Int. Cl. F04B 39/16; F04B 53/00; F04B 39/12

(52) U.S. Cl. CPC F04B 39/16; F04B 53/001; F04B 39/123; F16L 55/033

(57) ABSTRACT

An air compressor system having a compressor with an air inlet and an air outlet. An air filter is located in an air filter housing, and filters air before it is fed to the air inlet of the compressor. A first connector defined by the housing to be connected to a first air hose is furthermore provided for the purposes of intake and discharge of air from the air outlet of the compressor into the surroundings. The air to be discharged is conducted into the housing of the air filter into a prechamber, and thereafter is guided via the first connector into the surroundings.

### TECHNICAL FIELD

The embodiments relate to an air compressor system and to a corresponding air compressor assembly for such an air compressor system.

### BACKGROUND

DE 202020100475 U1 describes, for example, a noise suppressor for a vehicle compressed-air system for suppressing induction noise and/or discharge noise of the compressed-air system, having a housing which is filled with deadening material and which acts as a filter and noise suppressor.

Here, the noise suppressor can be used for reducing the induction and/or discharge noise of an air spring system that comprises an air spring compressor, wherein the noise suppressor is correspondingly arranged at an induction side and/or a discharge side of the air spring system, that is to say in each case one such noise suppressor is optionally provided at each of the induction side and the discharge side.

Owing to the generation of noise and owing to possible airborne particles, and not least owing to structural space requirements in the vehicle, defined positions in the vehicle are specified for the air inlet and the air outlet, which positions deviate considerably from the position of the compressor in the vehicle, which is likewise defined on the basis of technical aspects. For this reason, in each case one air hose is also provided, which air hose must be routed in a protected manner in the vehicle over a corresponding length.

It has thus hitherto been the case that a first air hose is provided for the induction of the air from the surroundings, along with an air filter in an air filter housing, through which the air thus filtered is fed to the air inlet of the compressor.

Furthermore, a second air hose has hitherto commonly been provided in order to discharge the air from the air outlet of the compressor into the surroundings at a defined position of the vehicle.

### SUMMARY

An air hose that leads to the surroundings to be used jointly both for induction and for discharge of the air from the compressor, and the air to be discharged is conducted into the housing of the air filter, and the air to be discharged is guided there into the common air hose and from there into the surroundings is provided. For the sake of improved understanding, note that a compressor normally either inducts air or discharges air in each case in chronologically offset working cycles, such that there is always a prevailing direction of the air movement in the common air hose.

The air filter itself is arranged in an air filter chamber in the interior of the air filter housing.

The air filter housing is equipped with a first connector for connecting a common air hose that leads to the surroundings and a second connector for delivering the air that has been purified by the air filter to an air inlet of a compressor, and furthermore a third connector for receiving the air that has been discharged by the compressor, wherein a prechamber is provided in the housing upstream of the air filter chamber, and the third connector and the first connector lead into the prechamber.

Upon a cycle changeover between induction and discharge of the air, turbulence can occur in the prechamber, and the discharged air can flow back into the air filter. However, this is not critical for the intended applications, because the discharged air is no more heavily contaminated than the inducted air, and the quality of the air does not itself change during the compression.

In one embodiment, provision is made for the third connector and the first connector to be led into a prechamber of the air filter housing, wherein the third connector has a wall that protrudes into the interior of the prechamber, and the air inlet from the prechamber into the air filter chamber is arranged so as to be laterally offset and shielded by the wall. Thus, owing to the protruding wall, the outflowing air is discharged past the air inlets into the prechamber, or the air inlets are shielded from the outflowing air.

As an alternative to this, in a second embodiment a valve is provided which at least largely closes the air inlet into the air filter chamber when air is discharged by the compressor through the third connector. The valve is self-evidently opened during or for the induction of the air.

In one refinement, the valve is moved between the valve positions by the air flow itself by virtue of the valve being formed as a body which is arranged with one wall surface in the air flow of the air discharged by the compressor and by virtue of a second wall surface that is operatively connected to said wall surface at least largely closing the opening between prechamber and filter chamber.

In a further embodiment, the valve has a cylinder jacket surface which externally surrounds and is mounted axially movably on the protruding wall of the third connector.

The cylinder jacket, on the one hand, and the wall of the third connector, on the other hand, each have at least one opening, which openings, in a first valve position, are situated one over the other in the direction of the prechamber such that the air from the compressor flows out into the prechamber through these openings situated one over the other. In a second valve position, the cylindrical main body is shifted into an offset position on the third connector such that the openings are arranged offset with respect to one another. Thus, air cannot flow out of the third connector into the prechamber, nor can air flow out of the prechamber into said third connector, with the inducted air rather being drawn into the filter chamber.

In a further embodiment, on the outside of the cylinder jacket, there is furthermore provided a surface which projects from said cylinder jacket and which, in the first valve position, at least largely closes an opening between prechamber and filter chamber and which, in the second valve position, opens up said opening. The valve thus acts alternately in both air flow directions.

In a further embodiment, the cylinder jacket of the valve is closed on the side facing toward the prechamber, and the air flow from the compressor impinges on said wall surface. In this way, the air flow itself can in each case automatically bring about the required valve setting.

The embodiments are suitable for the use of an air compressor system in a motor vehicle to generate an operating air pressure for an adaptive air spring damper system.

### BRIEF DESCRIPTION OF THE DRAWINGS

The invention will now be described in more detail below on the basis of exemplary embodiments and with reference to the figures, in which:

FIG. 1 shows a section through a first embodiment of an air filter housing;

FIG. 2 shows a pneumatic function diagram of a second embodiment with a valve;

FIG. 3 shows an enlarged illustration of a detail with a valve in the first position for the inflow of the air that is to be inducted;

FIG. 4 shows an enlarged illustration of a detail with a valve in the second position for the outflow of the air that is to be discharged;

FIG. 5 shows an embodiment of the valve in a three-dimensional illustration; and

FIG. 6 shows an embodiment of a wall which protrudes into the prechamber and has openings and onto which the valve is pushed and movably mounted.

### DETAILED DESCRIPTION

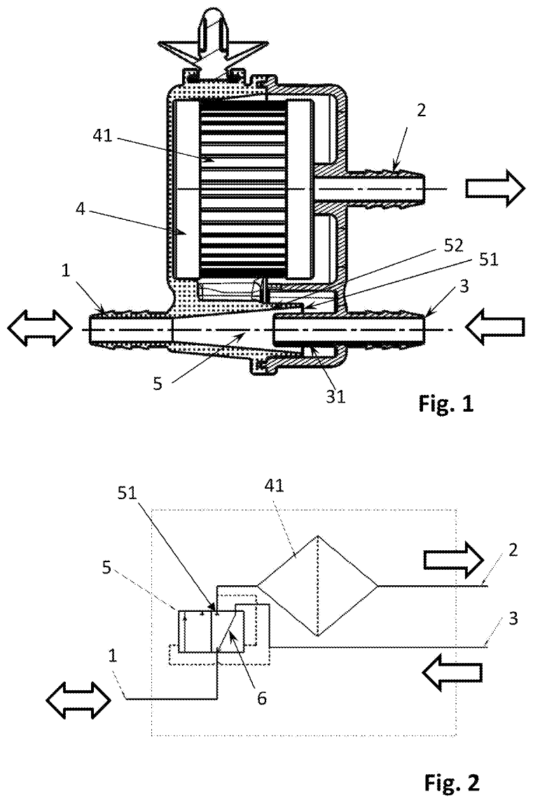

FIG. 1 shows an air filter housing 4 for an air compressor system which is not shown in any more detail in the figures but which is generally known from the prior art, having an air filter in an air filter chamber 41 in the interior of the air filter housing 4.

The housing 4 is provided with a first connector 1 for connecting a common air hose that leads to the surroundings, and with a second connector 2 for delivering the air that has been purified by the air filter 41 to an air inlet of a compressor.

The third connector 3 serves for receiving the air that has been discharged by the compressor back into the housing 4 of the air filter 41.

A prechamber 5 is provided in the housing 4 upstream of the air filter chamber 41, and the third connector 3 and the first connector 1 lead into the prechamber 5.

Here, the reference sign 51 denotes the opening between the prechamber 5 and the actual air filter chamber 41.

As is generally known, and correspondingly not shown here, such an air compressor system is furthermore also composed of a compressor with an air inlet and with an air outlet, wherein an air hose is provided for the induction of the air from the surroundings, along with the actual air filter 41 in the air filter housing 4, which has been substantially modified here. In general, the air filtered by the air filter 41 is fed to the air inlet of the compressor and is discharged from the air outlet of the compressor into the surroundings.

The air hose that leads to the surroundings is used jointly both for induction and for discharge, and the air to be discharged is conducted into the housing 4 of the air filter, and the air to be discharged is guided there into the common air hose and from there into the surroundings.

Since the air filter housing as an empty housing, that is to say without an air filter, and the air filter housing equipped with an air filter can be seen as units for such a compressor system. The air filter housing is designed in which air filter housing can self-evidently also serve as the noise suppressor and is correspondingly configured to be connected to an air hose and to the connectors of the compressor.

FIG. 1 shows an embodiment without an additional valve and shows a series of passive flow-guiding measures in order, in the different working cycles of the compressor, to guide the air flows in particular in the prechamber 5 and minimize turbulence or flow losses.

For this purpose, in the embodiment according to FIG. 1, the third connector 3 has a wall 31 which protrudes into the interior of the prechamber 5, and the air inlet 51 from the prechamber 5 into the air filter chamber 41 is arranged so as to be laterally offset and shielded by the wall 31. Additionally, the wall 52 of the prechamber 5 extends, with a corresponding spacing, over the wall 31 of the third connector 3.

Air flowing out of the third connector 3 is thus, in the prechamber 5, guided primarily to the first connector 1 and shielded from the air inlet 51 into the air filter chamber 41 by the protruding wall 31 of the third connector and by the wall portions 52 of the prechamber 5.

FIG. 2 shows a pneumatic diagram of a second alternative embodiment with a controllable valve 6, which connects the first connector 1, leading to the common air hose that leads to the surroundings, alternately either to the air inlet 51 into the air filter chamber 41 or, in the other valve position, to the third connector. Here, the thick arrows also indicate the flow direction of the air in each case, wherein it is emphasised once again that the compressor operates in two separate working cycles, that is to say in one cycle inducts the air from the air filter, and in the second cycle chronologically offset in relation thereto discharges the air again, such that the two different air flows in the common air hose at the connector 1 specifically do not occur at the same time, with the air rather flowing in each case in opposite directions in said common hose in accordance with the working cycles.

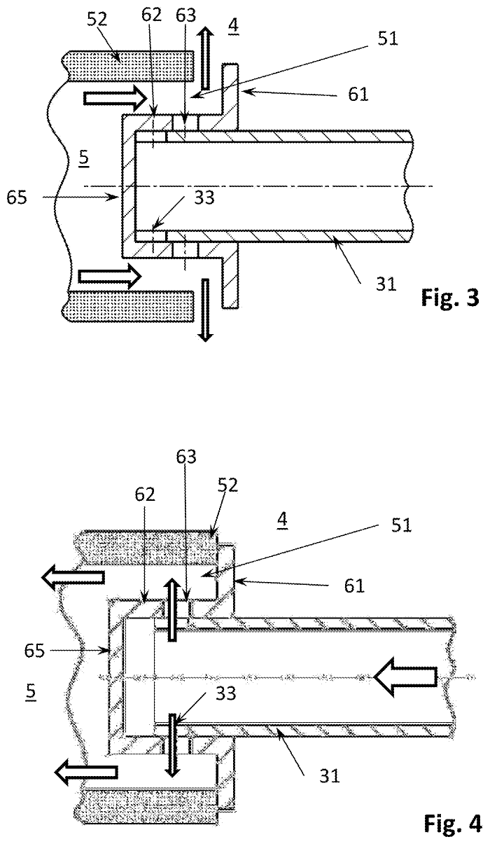

FIGS. 3 and 4 now show, in greater detail, said embodiment having a movable valve 6, with FIG. 3 firstly showing the working cycle of the induction of the air from the surroundings via the prechamber 5 into the air filter 41 by the compressor. Here, the valve 6 is composed of a first effective surface 61, which can close, and in FIG. 3 self-evidently hold open, the air inlet 51 between the prechamber 5 and the air filter chamber 41.

By contrast to this, FIG. 4 shows the valve position of the valve 6 in which the effective surface 61 adjoins the wall 52 of the prechamber 52, and thus at least largely closes the air inlet 51, when air is discharged through the first connector 3 by the compressor. In the context of this application, “at least largely” means that a closure which is adequate for the efficiency is achieved, even though such movable parts can self-evidently never achieve sealing by 100 percent, nor would this actually be required for the present application.

Here, the valve 6 may be moved between the valve positions by the air flow itself by virtue of the valve 6 being formed as a body which is arranged with a second wall surface 65 in the air flow of the air discharged by the compressor and by virtue of a first wall surface 61 that is operatively connected to said second wall surface 65 at least largely closing the opening 51 between prechamber 5 and filter chamber 41.

The valve 6 according to the embodiment in FIGS. 3-5 has a cylinder jacket surface 62 which externally surrounds and is mounted axially movably on the protruding cylindrical wall 31 of the third connector 3.

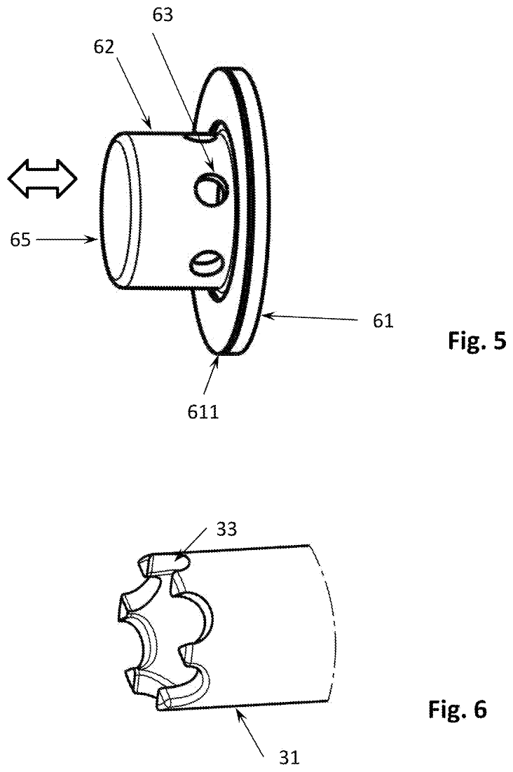

The cylinder jacket 62, on the one hand, and the wall 31 of the third connector, on the other hand, each have at least one opening 33, 63 in FIGS. 3 and 4, openings can be seen at least on mutually opposite sides, that is to say two openings can be seen, and FIG. 5 shows yet further rotationally symmetrically arranged further openings, wherein, in a first valve position, the openings 33, 63 are situated one over the other, that is to say form a through opening, into the prechamber 5 such that the air from the compressor via the third connector 3 flows out into the prechamber 5 through these openings 33, 63 situated one over the other, as indicated in FIG. 4 by the arrows.

In the second valve position shown in FIG. 3, the cylindrical main body 62 of the valve 6 is shifted into an offset position on the third connector 3 such that the openings 33, 63 are arranged offset with respect to one another and the third connector 3 is at least largely closed off with respect to the prechamber 5. The air from the surroundings can thus pass via the first connector 1 through the prechamber 5 and through the open air inlet 51 into the air filter chamber 41, and thus through the air filter to the compressor.

As can be seen for example in FIG. 5, in this embodiment, on the outside of the cylinder jacket 62, a surface 61 which projects from said cylinder jacket is provided as a corresponding effective surface, which, in the first valve position, at least largely closes the opening 51 between prechamber 5 and filter chamber 41 and which, in the second valve position, opens up said opening 51. Here, a correspondingly elastic seal element 661 may additionally be provided on that side of the effective surface 61 which is directed toward the wall 52 of the prechamber 5. Furthermore, in FIG. 5, the rotationally symmetrically arranged openings 63 and the wall 65 are illustrated as a closure of the cylinder jacket 62 in the direction of the prechamber 5, and it is readily apparent how said wall 65 is impinged on by the corresponding air flows and causes a movement of the valve 6.

FIG. 6 correspondingly shows an illustration of the wall 31 of the third connector, which wall protrudes into the prechamber 5 and has the corresponding openings 33.

1. An air compressor system having a compressor with an air inlet and with an air outlet comprising:
an air filter in an air filter housing, wherein air is filtered prior to being fed to the air inlet of the compressor;
a first connector having a first air hose, for both air intake and air discharge to surroundings of the air filter;
a second connector having a second air hose for transfer of air from the air filter to the air inlet of the compressor;
a third connector having a third air hose for the purposes of discharging air from the air outlet of the compressor into the surroundings; and
wherein the air to be discharged is conducted into the housing of the air filter then to the surroundings via the first connector.

2. The air compressor system as claimed in claim 1, further comprising a prechamber defined by the housing upstream of an air filter chamber defined by the housing, and the first connector and the third connector lead into the prechamber.

3. The air compressor system as claimed in claim 2, wherein, wherein the third connector has a wall that protrudes into an interior of the prechamber, and an air inlet from the prechamber into the air filter chamber is laterally offset and shielded by the wall.

4. The air compressor system as claimed in claim 2, further comprising a valve which at least largely closes the air inlet into the air filter chamber when air is discharged by the compressor through the third connector.

5. The air compressor system as claimed in claim 4, wherein the valve is moved between valve positions by the air flow by virtue of a first wall surface in the air flow of the air discharged by the compressor and a second wall surface that is operatively connected to the first wall surface, wherein the second wall surface at least largely closes the opening between prechamber and filter chamber.

6. The air compressor system as claimed in claim 4, further comprising:
a cylinder jacket surface of the valve which externally surrounds and is mounted axially movably on the protruding cylindrical wall of the third connector;
wherein the cylinder jacket and the wall of the third connector each define at least one opening;
wherein in a first valve position the openings are situated one over the other into the prechamber such that the air from the compressor via the third connector flows out into the prechamber through these openings situated one over the other; and
wherein in a second valve position the cylindrical main body is shifted into an offset position on the third connector such that the openings are arranged offset with respect to one another and the third connector is at least largely closed off with respect to the prechamber.

7. The air compressor system as claimed in claim 6, wherein on the outside of the cylinder jacket, there is a surface which projects from said cylinder jacket and which, in the first valve position, at least largely closes the opening between prechamber and filter chamber and which in the second valve position opens up the opening.

8. The air compressor system as claimed in claim 5, wherein the cylinder jacket of the valve is closed on the side facing toward the prechamber, and the air flow from the compressor impinges on said wall surface.

9. The air compressor system as claimed in claim 1, wherein the air compressor is located in a motor vehicle and is used to generate an operating air pressure for an adaptive air spring damper system.

10. An air filter assembly for an air compressor system having a compressor with an air inlet and with an air outlet comprising:
an air filter housing;
an air filter located in the air filter housing, wherein air is filtered prior to being fed to the air inlet of the compressor;
a first connector, for both air intake and air discharge to surroundings of the air filter assembly;
a second connector for transfer of air from the air filter to the air inlet of the compressor;
a third connector for the purposes of discharging air from the air outlet of the compressor into the surroundings of the air filter assembly; and
wherein the air to be discharged is conducted into the housing of the air filter then to the surroundings via the first connector.

11. The air filter assembly as claimed in claim 10, further comprising a prechamber defined by the housing upstream of an air filter chamber also defined by the housing, wherein the first connector and the third connector lead into the prechamber.

12. The air filter assembly as claimed in claim 11, wherein the third connector has a wall that protrudes into an interior of the prechamber, and an air inlet from the prechamber into the air filter chamber is laterally offset and shielded by the wall.

13. The air filter assembly as claimed in claim 11, further comprising a valve which at least largely closes the air inlet into the air filter chamber when air is discharged by the compressor through the third connector.

14. The air filter assembly as claimed in claim 13, wherein the valve is moved between valve positions by the air flow by virtue of a first wall surface in the air flow of the air discharged by the compressor and a second wall surface that is operatively connected to the first wall surface, wherein the second wall surface at least largely closes the opening between prechamber and filter chamber.

15. The air filter assembly as claimed in claim 13, further comprising:
a cylinder jacket surface of the valve which externally surrounds and is mounted axially movably on the protruding cylindrical wall of the third connector; wherein the cylinder jacket and the wall of the third connector each define at least one opening;
wherein in a first valve position the each at least one openings are situated one over the other into the prechamber such that the air from the compressor via the third connector flows out into the prechamber through these openings situated one over the other; and
wherein in a second valve position the cylindrical main body is shifted into an offset position on the third connector such that the openings are arranged offset with respect to one another and the third connector is at least largely closed off with respect to the prechamber.

16. The air filter assembly as claimed in claim 15, wherein on the outside of the cylinder jacket, there is a surface which projects from said cylinder jacket and which, in the first valve position, at least largely closes the opening between prechamber and filter chamber and which in the second valve position opens the opening.

17. The air filter assembly as claimed in claim 14, wherein the cylinder jacket of the valve is closed on the side facing toward the prechamber, and the air flow from the compressor impinges on said wall surface.

18. The air filter assembly as claimed in claim 10, wherein the air filter assembly is used by an air compressor located in a motor vehicle and is used to generate an operating air pressure for an adaptive air spring damper system.
